(19) United States
(12) Patent Application Publication
(10) Pub. No.: US 2018/0018124 A1
(43) Pub. Date: Jan. 18, 2018

(54) DATA ARRANGEMENT APPARATUS AND DATA ARRANGEMENT METHOD

(71) Applicant: NEC Solution Innovators, Ltd., Koto-ku, Tokyo (JP)

(72) Inventor: Yoshihiro KUDO, Tokyo (JP)

(73) Assignee: NEC Solution Innovators, Ltd., Koto-ku, Tokyo (JP)

(21) Appl. No.: 15/545,788

(22) PCT Filed: Jul. 23, 2015
(86) PCT No.: PCT/JP2015/070967

§ 371 Date: Jul. 24, 2017

(30) Foreign Application Priority Data
Feb. 19, 2015 (JP) 2015-030619

(51) Int. Cl. G06F 3/06

(52) U.S. Cl. CPC G06F 3/0647; G06F 3/0608; G06F 3/0683

(57) ABSTRACT

A data arrangement apparatus (100) includes: a file moving unit (101) moving a data file stored in a storage apparatus to a different storage apparatus; and an arrangement control unit (102) determining whether or not to associate trigger information for activating an agent application on a user terminal with a link file of the data file to be moved when the data file is moved between storage apparatuses by the file moving unit (101), based on a type of a storage apparatus of a movement destination.

### TECHNICAL FIELD

The present invention relates to a data storage technique.

### BACKGROUND ART

With the development of an information communication technique, a sensing technique, or the like, all types of information are converted into data. How to collect and use such various types of enormous data, so-called big data, becomes one of technology trends. Since the generated and collected data are valuable assets, a data storage technique is considered to be important. There are techniques to store a large amount of data for a long period while moving data between a plurality of storage devices. Such a technique is sometimes called an archive.

Patent Document 1 below proposes a storage management system in which movement to a secondary storage can be completely hidden from a client. The system automatically moves a real file from a primary storage to a secondary storage and stores a stub file corresponding to the real file in the primary storage. If a file access request for the primary storage is issued from the client, in a case where a target file is a stub file, the real file in the secondary storage is accessed based on information on the stub file, and an access result is returned to the client. Further, Patent Document 2 below proposes a method of creating a shortcut indicating an actual position of a file in a storage location before the file is moved, in a case where the file is moved. Patent Document 3 below proposes an electronic file management method for providing the same operation environment to a user before and after the movement of an electronic file. According to this method, if the electronic file is written into a management target storage area of a certain storage unit, when the free space of the management target storage area is equal to or less than a predetermined value, the electronic file in the selected management target storage area is moved to another storage area of another storage unit. According to this method, link information of the moved electronic file is generated along with the movement, and the presence of the electronic file is displayed at the display position before the movement, based on the link information.

### RELATED DOCUMENT

### Patent Document

[Patent Document 1] Japanese Patent Application Publication No. 2006-164211

[Patent Document 2] Japanese Patent Application Publication No. 2007-293619

[Patent Document 3] Japanese Patent Application Publication No. 2008-112254

### SUMMARY OF THE INVENTION

### Technical Problem

For storing data, various types of storage devices are used such as a disk array apparatus including a plurality of hard disk drives (HDD) or solid state drives (SSD) mounted thereon, a magnetic tape drive, an autochanger-type storage device in which a plurality of magnetic tapes and optical disks are accommodated and are automatically switched for use. Such storage devices differ in processing speed, storage capacity, price, or the like for respective types. Whereas the disk array apparatus has generally high performance and high price, the storage device using magnetic tapes are lower in speed and cost than the disk array apparatus. In order to store a large amount of data for a long time, it is important to lower the storage cost of data.

On the other hand, the user does not want data access operations to be complicated. For example, even in a case of accessing data that has not been used for a long time, it is desirable to be able to easily know the location where the data is present and to easily access the data.

However, in the magnetic tape drive or the autochanger-type storage device, it may sometimes be necessary to switch a storage medium such as a magnetic tape, to access a data file. In other words, there are storage devices that cannot seamlessly access data files. In the method using the shortcut or the symbolic link as in the above proposed method, it is not possible to appropriately support the data file moved to such a storage device.

The present invention has been made in view of such circumstances, and provides a data storage technique that does not impair the convenience of data usage while reducing the storage cost of data.

### Solution to Problem

In each aspect of the present invention, the following configurations are respectively adopted in order to solve the above-mentioned problems.

A first aspect relates to a data arrangement apparatus. The data arrangement apparatus according to the first aspect includes: a file moving unit moving a data file stored in a storage apparatus to a different storage apparatus; and an arrangement control unit determining whether or not to associate trigger information for activating an agent application on a user terminal with a link file of the data file to be moved when the data file is moved between storage apparatuses by the file moving unit, based on a type of the storage apparatus of a movement destination.

A second aspect relates to a data arrangement method executed by at least one computer accessible to a plurality of storage apparatuses. The data arrangement method according to the second aspect includes: moving a data file stored in a storage apparatus to a different storage apparatus; and determining whether or not to associate trigger information for activating an agent application on a user terminal with a link file of the data file to be moved, based on the type of the storage apparatus of a movement destination.

A third aspect relates to a program for an agent application executed by a user terminal accessible to a primary storage apparatus. The agent application is activated by a user operation on a link file on the primary storage apparatus, the link file being generated for a data file stored in a near line storage apparatus including a cloud storage and an offline storage apparatus in which a plurality of removable storage media can be switched and used, and the agent application includes: an information acquisition process of acquiring file information of the data file and movement destination information from the link file; and a transmission process of transmitting the file information and the movement destination information to a data arrangement apparatus accessible to the primary storage apparatus an the near line storage apparatus, in order for the data arrangement apparatus to move the data file from the near line storage apparatus to the primary storage apparatus.

Note that, another aspect of the present invention is a program causing at least one computer to execute the method of the second aspect and a computer-readable storage medium storing the program. In addition, still another aspect is a program relating to the third aspect and a computer-readable storage medium storing the program. The storage medium includes a non-transitory tangible medium.

### Advantageous Effects of Invention

According to the above respective aspects, it is possible to provide a data storage technique that does not impair the convenience of data usage while reducing the storage cost of data.

### BRIEF DESCRIPTION OF THE DRAWINGS

The foregoing and other objects, features and advantages will become more apparent from the following description of preferred exemplary embodiments and the accompanying drawings.

FIG. 1 conceptually shows an example of a hardware configuration of an archive system according to a first exemplary embodiment.

FIG. 2 conceptually shows an example of a hardware configuration of a user terminal accessing a primary storage apparatus.

FIG. 3 conceptually shows an example of a processing configuration of a data arrangement apparatus of the first exemplary embodiment.

FIG. 4 conceptually shows an example of a processing configuration of the user terminal accessing the primary storage apparatus.

FIG. 5 is a flowchart showing an operation example of the data arrangement apparatus related to storage of a data file.

FIG. 6 is a flowchart showing an operation example of the data arrangement apparatus and the user terminal at the time of access to a data file.

FIG. 7 conceptually shows transition of arrangement of a data file.

FIG. 8 conceptually shows transition of arrangement of a data file in a third modification.

FIG. 9 conceptually shows an example of a processing configuration of a data arrangement apparatus of a second exemplary embodiment.

FIG. 10 is a flowchart showing an operation example of the data arrangement apparatus of the second exemplary embodiment.

### DESCRIPTION OF EMBODIMENTS

Hereinafter, exemplary embodiments of the present invention will be described. Note that, each of the following exemplary embodiments is an example, and the present invention is not limited to the configurations of the following respective exemplary embodiments.

### First Exemplary Embodiment

A data arrangement apparatus and a data arrangement method of a first exemplary embodiment will be described with reference to a plurality of drawings, below.

### System Configuration

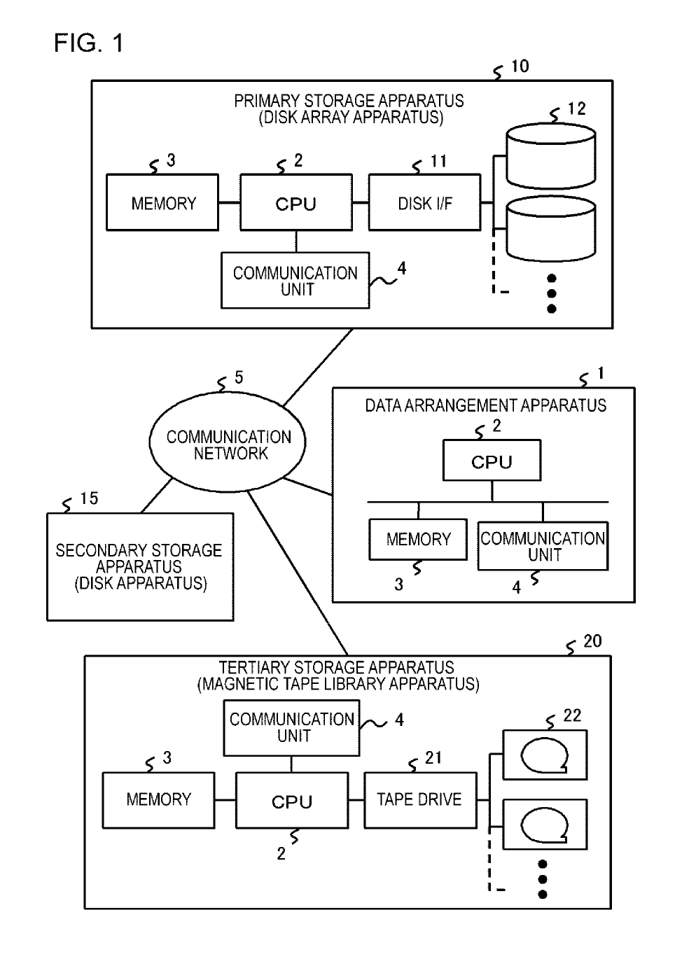

FIG. 1 conceptually shows an example of a hardware configuration of an archive system according to a first exemplary embodiment. An archive system of the first exemplary embodiment includes a data arrangement apparatus 1, a primary storage apparatus 10, a secondary storage apparatus 15, and a tertiary storage apparatus 20. The respective apparatuses are connected to each other through a communication network 5. The communication network 5 is formed by at least one of a public network such as the Internet, a Wide Area Network (WAN), a Local Area Network (LAN), a wireless communication network, a storage area Network (SAN), and the like. In the present exemplary embodiment, the communication form between respective apparatuses is not limited. Further, although it is described only about archiving, i.e. storing data, in the present exemplary embodiment, each apparatus may also include other functions such as backup (data duplication protection) function.

The data arrangement apparatus 1 enables long-term storage of large amount of data, while transferring each data file stored in the primary storage apparatus 10 that is accessed from the user terminal 6, to one of the secondary storage apparatus 15 and the tertiary storage apparatus 20. The data arrangement apparatus 1 is a so-called computer, and includes a Central Processing Unit (CPU) 2, a memory 3, a communication unit 4, or the like. The memory 3 is a Random Access Memory (RAM), a Read Only Memory (ROM), an auxiliary storage apparatus (such as a hard disk). The communication unit 4 communicates with other apparatuses through the communication network 5, or exchanges signals with other apparatuses. A portable storage medium or the like is also connected to the communication unit 4. The data arrangement apparatus 1 may include hardware elements not shown in FIG. 1, and the hardware configuration of the data arrangement apparatus 1 is not limited. Further, the number of respective hardware elements is not limited to the number (one) shown in FIG. 1.

The primary storage apparatus 10 is a file server accessed from the user terminal 6. Therefore, it is desirable that a faster storage apparatus than the secondary storage apparatus 15 and the tertiary storage apparatus 20 is employed as the primary storage apparatus 10. In FIG. 1, a general disk array apparatus is illustrated as the primary storage apparatus 10. The primary storage apparatus 10 includes a CPU 2, a memory 3, a communication unit 4, a disk interface (I/F) 11, and a plurality of HDDs 12. The disk I/F 11 is connected to the plurality of HDDs 12, and controls the exchange of the data file written to each of the HDDs 12 and the data file read out from each of the HDDs 12. The disk I/F 11 supports interfaces such as Serial Attached Small Computer System Interface (Serial Attached SCSI (SAS)), and Serial Advanced Technology Attachment (Serial ATA (SATA)). The HDD 12 may be an SSD. However, the primary storage apparatus 10 may be a Network Attached Storage (NAS).

The secondary storage apparatus 15 is a disk apparatus including a disk drive. The secondary storage apparatus 15 may be the same disk array apparatus as the primary storage apparatus 10 or may be a NAS. The secondary storage apparatus 15 may include the same hardware elements as those of the primary storage apparatus 10. Since the secondary storage apparatus 15 is used for archive, it is desirable to employ an apparatus that is slower in processing speed than the primary storage apparatus 10 and is suitable for inexpensive data saving.

The tertiary storage apparatus 20 is a magnetic tape library apparatus. The tertiary storage apparatus 20 includes a CPU 2, a memory 3, a communication unit 4, a tape drive 21, a tape cartridge 22, and the like. The tape cartridge 22 is one of removable storage media with a built-in magnetic tape. The tertiary storage apparatus 20 is formed to accommodate a plurality of tape cartridges 22. By being controlled by the CPU 2, the tape drive 21 transports the tape cartridge 22 to be accessed to a predetermined position and accesses the magnetic tape in the transported tape cartridge 22 using a magnetic head unit (not shown). The CPU 2 writes (stores) the data file received from another apparatus by the communication unit 4, onto the magnetic tape of one of the tape cartridges 22. Further, the CPU 2 reads the specified data file from one of the tape cartridges 22, based on the instruction received from the data arrangement apparatus 1 by the communication unit 4.

In the present specification, a storage apparatus that can become a state in which it is impossible to seamlessly access the data file even in a normal state, such as a magnetic tape library apparatus, is collectively referred to as a “near line storage apparatus”. In a case of accessing the data file stored in the tape cartridge 22 to which the magnetic head unit is not accessibly mounted, the magnetic tape library apparatus or the magnetic tape drive needs to change the tape cartridge 22. In other words, the state in which it is impossible to access the desired data file unless the tape cartridges 22 are switched is a state in which it is impossible to seamlessly access the data file even in a normal state.

Further, in the present specification, storage apparatuses in which removable storage media (tape cartridges 22) are switched and used, such as a magnetic tape library apparatus or a magnetic tape drive, may collectively be referred to as “offline storage apparatus”. The “offline storage apparatus” also includes a compact disk (CD) drive, a digital versatile disk (DVD) drive, and a Blu-ray disk drive. Further, an apparatus having a USB port to which a universal serial bus (USB) memory, a portable HDD, or the like can be connected can also be called an “offline storage apparatus”. Such an “offline storage apparatus” is a type of “near line storage apparatus”.

The “near line storage apparatus” may further include a cloud storage. That is because it is unknown for the user what type of storage apparatus configuration the cloud storage has, and it can become a state in which it is impossible to seamlessly access the data file even in a normal state. The cloud storage is also included in “storage apparatus” written in this specification.

In the example of FIG. 1, the tertiary storage apparatus 20 is a magnetic tape library apparatus, but the tertiary storage apparatus 20 may be a near line storage apparatus other than the magnetic tape library apparatus. In the present exemplary embodiment, the secondary storage apparatus 15 is used as a temporary storage apparatus for moving the data file to the tertiary storage apparatus 20, so it is desirable that the secondary storage apparatus 15 is a disk apparatus not belonging to the near line storage apparatus. Further, there may be a plurality of secondary storage apparatuses 15 and tertiary storage apparatuses 20. The hardware configuration of each storage apparatus is not limited to the example shown in FIG. 1.

The user terminal 6 accesses the primary storage apparatus 10, generates and stores a data file in the storage area of the primary storage apparatus 10, and refers to the data file. The user terminal 6 displays the data files stored in the primary storage apparatus 10 and link files in a tree structure.

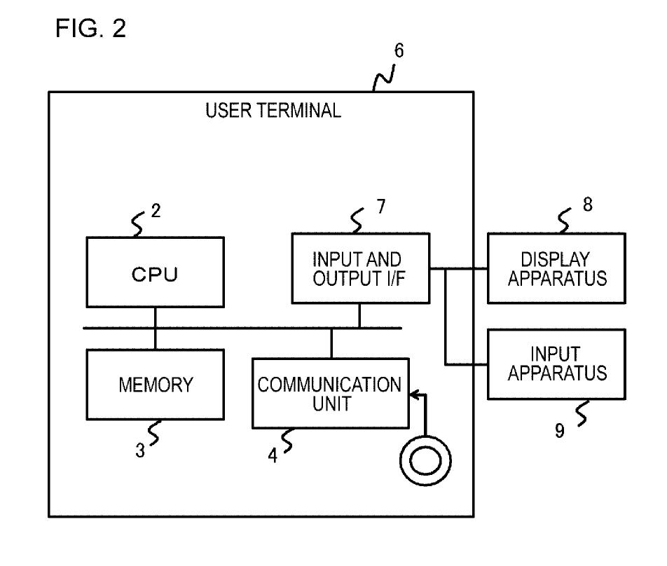

FIG. 2 is a diagram conceptually showing an example of the hardware configuration of the user terminal 6 accessing the primary storage apparatus 10. The user terminal 6 is a so-called computer such as a Personal Computer (PC), a mobile phone, a smartphone, and a tablet terminal. For example, the user terminal 6 includes a CPU 2, a memory 3, a communication unit 4, an input and output interface (I/F) 7, and the like. The input and output I/F 7 can be connected to a user interface device, such as the display device 8 and the input device 9. The display device 8 is a device that displays a screen corresponding to drawing data processed by the CPU 2 or the like, such as a Liquid Crystal Display (LCD) or a Cathode Ray Tube (CRT) display. The input device 9 is a device that accepts an input of a user operation, such as a keyboard, a mouse, or the like. The display device 8 and the input device 9 may be integrated and realized as a touch panel. The hardware configuration of the user terminal 6 is not limited.

### Processing Configuration

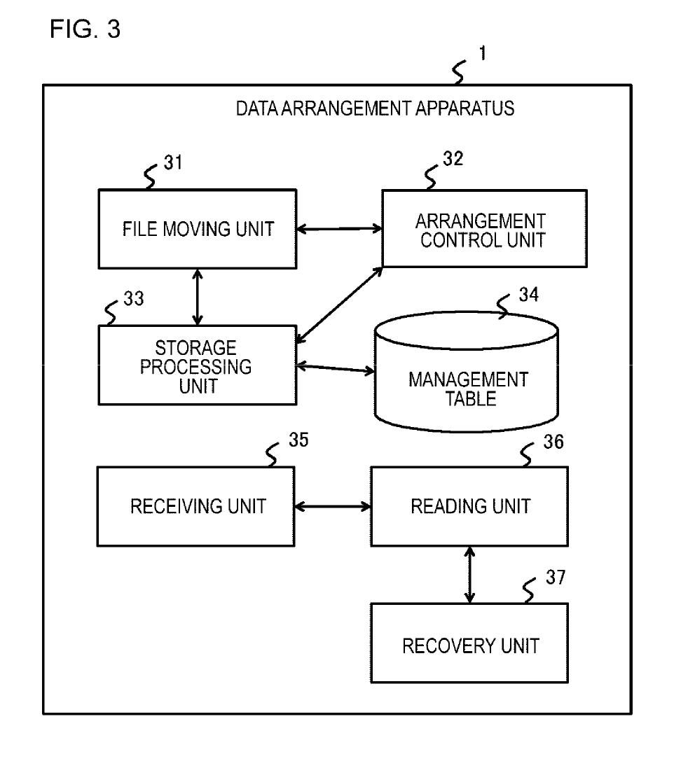

FIG. 3 is a diagram conceptually showing a processing configuration example of the data arrangement apparatus 1 in the first exemplary embodiment. The data arrangement apparatus 1 includes a file moving unit 31, an arrangement control unit 32, a storage processing unit 33, a management table 34, a receiving unit 35, a reading unit 36, a recovery unit 37, and the like. Each processing module is realized, for example, by the CPU 2 executing a program stored in the memory 3. Further, the program may be installed from a portable storage medium such as a Compact Disc (CD), a memory card, or the like or from another apparatus connected to the communication network 5 through the communication unit 4, and stored in the memory 3.

The file moving unit 31 moves a data file stored in the primary storage apparatus 10 to a different storage apparatus. Specifically, the file moving unit 31 moves the data file stored in the primary storage apparatus 10 to the secondary storage apparatus 15, and further moves the data file having been moved to the secondary storage apparatus 15 to the tertiary storage apparatus 20. As described above, before moving the data file to the near line storage apparatus (tertiary storage apparatus 20), the file moving unit 31 moves the data file to a specific storage apparatus (secondary storage apparatus 15) being different type from the near line storage apparatus. When moving the data file from the secondary storage apparatus 15 to the tertiary storage apparatus 20, it is desirable that the file moving unit 31 writes the copy of the data file into the tertiary storage apparatus 20, and deletes the original data file on the secondary storage apparatus 15 after the writing is finished. This makes it possible to prevent the data file from being unable to be accessed while writing the data file into the tertiary storage apparatus 20.

The file moving unit 31 may check the usage rate of the primary storage apparatus 10, as a condition for moving the data file from the primary storage apparatus 10 to a different storage apparatus. Specifically, the file moving unit 31 does not move the data file in a case where the usage rate of the primary storage apparatus 10 is lower than the predetermined threshold, whereas the file moving unit 31 moves the data file in a case where the usage rate becomes equal to or higher than the predetermined threshold. Thus, the user can maximize the use of the primary storage apparatus 10 and maximally enjoy the high speed property of the primary storage apparatus 10. Instead of the usage rate, the usage amount itself may be used. In this case, the predetermined threshold may be determined as a value considering the capacity of the primary storage apparatus 10.

The file moving unit 31 selects a data file to be moved to the secondary storage apparatus 15 out of a plurality of data files stored in the primary storage apparatus 10, depending on whether or not a no-access period and a file size satisfy a predetermined condition. Specifically, the file moving unit 31 selects, as a movement target, a data file which has a size not less than a predetermined upper limit size or not more than a predetermined lower limit size and which has not been updated or referred to for a predetermined period or longer. This is because the degree of influence on the user convenience is small in total even if a data file the access frequency of which is low is stored in a storage apparatus having a low processing speed and it takes time to access the data file. The predetermined upper limit size is set to, for example, a value that is considered to have a small influence on the storage capacity of the primary storage apparatus 10, even if the data file is not moved. A predetermined lower limit size is set to, for example, a value that is considered to be less useful because the amount of information is small. The predetermined condition for selecting the data file to be moved is appropriately determined depending on the configuration of the archive system, the use environment, and the like.

Before moving the data file stored in the secondary storage apparatus 15 to the tertiary storage apparatus 20, the file moving unit 31 checks the presence of the link file on the primary storage apparatus 10, corresponding to the data file. The checking can be realized, for example, by searching for a link file including the file name of the data file in a part thereof. In addition, the checking can also be realized by searching for a link file including the file information or movement destination information (storage location) of the data file in a part thereof.

The user can delete the unnecessary data file by operating the user terminal 6. In a case where the unnecessary data file is stored in the primary storage apparatus 10, the data file itself is deleted by a user operation. As will be described later, in a case where the data file is moved from the primary storage apparatus 10 to a different storage apparatus, the link file of the data file is left in a folder (also called a directory) on the primary storage apparatus 10 where the data file was stored. In a case of deleting the data file moved to a different storage apparatus, the user deletes the link file corresponding to the data file. Therefore, since the data file that is stored in the storage apparatus other than the primary storage apparatus 10 and the corresponding link file of which is not present in the primary storage apparatus 10 is a file that the user intends to delete, it can be called an orphaned file. As a result of the above checking, the file moving unit 31 cancels the movement for the data file to which the corresponding link file is not present, that is, an orphan file. The file moving unit 31 may delete the data file determined to be an orphan file from the secondary storage apparatus 15.

In a case where the file moving unit 31 moves the data file between storage apparatuses, the arrangement control unit 32 generates or updates the link file of the data file to be moved, which is stored in the primary storage apparatus 10. Specifically, in a case where a data file is moved from the primary storage apparatus 10 to the secondary storage apparatus 15, the arrangement control unit 32 generates a link file of the data file in a folder on the primary storage apparatus 10 where the data file was stored. The link file includes the storage location information of the data file, instead of the data file itself. The storage location information is information including the file name and indicating the path to the data file. In this case, information indicating the storage location of the data file in the secondary storage apparatus 15 is included, as the storage location information. The link file can also be called a shortcut file or a symbolic link file.

In a case where the data file is moved from the secondary storage apparatus 15 to the tertiary storage apparatus 20, the arrangement control unit 32 associates trigger information for activating an agent application on the user terminal 6 with the link file of the data file that is stored in the primary storage apparatus 10. In addition, the arrangement control unit 32 includes, in the link file, the identification information of the tape cartridge 22 that is the storage location of the data file in the tertiary storage apparatus 20. In this way, in a case where the type of the storage apparatus of the movement destination is a near line storage apparatus, the arrangement control unit 32 associates the trigger information with the link file on the primary storage apparatus 10 and includes, in the link file, movement destination information indicating the storage location of the storage apparatus of the movement destination.

Here, “activation of an agent application” does not mean only to load the program of the agent application into a main memory and newly generate a process (including a program execution image and CPU information), which is an execution unit of the program, but also includes causing the already generated process of the agent application to start processing.

A concrete method of associating the trigger information with the link file is not limited. For example, the arrangement control unit 32 adds a predetermined extension (.tap, .gap, or the like) to the link file. If the agent application is associated with the predetermined extension in the user terminal 6, it is possible to make the user terminal 6 to activate the agent application by operating the link file. Further, in a case where the information of the application to be executed (such as the path of an executable file) can be set in the link file, the arrangement control unit 32 can also set the path of the executable file of the agent application in the link file. The agent application will be described later.

Further, in a case where the data file is moved to the near line storage apparatus, the arrangement control unit 32 may update the link file of the data file on the primary storage apparatus so as to be displayed as an icon image corresponding to the near line storage apparatus. For example, in a case where an icon image corresponding to a magnetic tape library apparatus is associated with the agent application, the arrangement control unit 32 adds a predetermined extension to the link file as described above. Further, in a case where it is possible to associate an icon image with each link file, the arrangement control unit 32 may associate the icon image corresponding to the magnetic tape library apparatus with the link file. By doing so, since the link file is displayed with the icon image in the user terminal 6, the user can recognize that the data file has been moved to the tertiary storage apparatus 20 that it takes time to access, by seeing the icon image.

The storage processing unit 33 writes into the management table 34 the identification information of the storage medium and the file information of each data file written in the storage medium in a state of being associated with each other. Specifically, in a case where the data file is moved to the tertiary storage apparatus 20 by the file moving unit 31, the storage processing unit 33 writes into the management table 34 the file information of the data file and the identification information of the tape cartridge 22 in which the data file is stored, which are associated with each other. The storage processing unit 33 may also write information indicating the file position on the magnetic tape of the tape cartridge 22 in association with file information or the like.

The storage processing unit 33 can generate screen data for displaying the list of information stored in the management table 34 on the administrator terminal (not shown), and transmit the screen data to the administrator terminal. Thereby, for example, the storage processing unit 33 can display a management screen for displaying a list of stored data files on the administrator terminal, for each tape cartridge 22. Further, in response to the query from the administrator terminal, the storage processing unit 33 can display a management screen for displaying a list that associates the file information of the data file matching the condition of the query and the identification information of the tape cartridge 22 storing the data file, on the administrator terminal. Thus, it is also possible to deal with cases where it is desired to access a plurality of data files stored in the tertiary storage apparatus 20 at one time or the like.

The receiving unit 35 receives movement destination information and file information that the user terminal 6 transmits by the agent application being executed. The agent application is executed when the link file is operated and the user requires the reference of the data file stored in the tertiary storage apparatus 20. The movement destination information and file information received by the receiving unit 35 is information on the data file that the user requires to refer.

The reading unit 36 reads the data file indicated by the file information received by the receiving unit 35, from the storage location in the tertiary storage apparatus 20 indicated by the movement destination information received by the receiving unit 35. Since the tertiary storage apparatus 20 is a near line storage apparatus, the reading unit 36 reads the data file from the tape cartridge 22 indicated by the movement destination information.

In addition, in a case of receiving a request to read out the specified data file by a user operation on the above-described management screen, the reading unit 36 can reads out the specified data based on the information stored in the management table 34. The read data file is transmitted, for example, to the administrator terminal described above.

The recovery unit 37 places the data file read by the reading unit 36 in the folder on the primary storage apparatus 10 where the corresponding link file is present, and deletes the link file. That is, the recovery unit 37 returns the data file moved to the tertiary storage apparatus 20 to the primary storage apparatus 10.

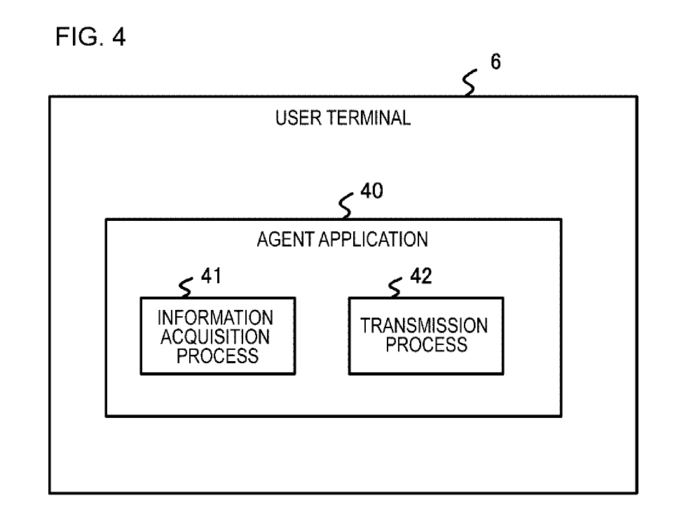

FIG. 4 is a diagram conceptually showing an example of a processing configuration of the user terminal 6 accessing the primary storage apparatus 10. A program of the agent application 40 is installed in the user terminal 6. The program of the agent application 40 is installed from a portable storage medium such as a CD and a memory card, or from another apparatus through the communication unit 4 and stored in the memory 3. The agent application 40 is realized by the CPU 2 executing the program stored in the memory 3.

The agent application 40 is activated by a user operation on the link file on the primary storage apparatus 10, the link file being generated with respect to the data file that is moved from the primary storage apparatus 10 and stored in the tertiary storage apparatus 20. Specifically, the agent application 40 is activated by the user operating the link file associated with the trigger information using the user terminal 6. In a case where a process that is an execution unit of the program of the agent application 40 has not being generated, the program of the agent application is loaded into a main memory and a process which is an execution unit of the program is generated, by the user operation. In addition, in a case where the process of the agent application has already been generated, the process is started by the user operation. The agent application 40 includes an information acquisition process 41 and a transmission process 42.

The information acquisition process 41 acquires file information and movement destination information from the operated link file. The file information includes the information of the data file stored in the tertiary storage apparatus 20, and the movement destination information includes the identification information of the tape cartridge 22 in which the data file is stored.

The transmission process 42 transmits the file information and the movement destination information acquired by the information acquisition process 41, to the data arrangement apparatus 1. The transmitted file information and movement destination information is received by the receiving unit 35 described above. As a result, the data file corresponding to the operated link file is moved from the tertiary storage apparatus 20 to the primary storage apparatus 10, and become a state where it can be referred to.

Before executing the transmission process 42, the agent application 40 can display a confirmation message on the display device 8 of the user terminal 6 (display process). Since the tertiary storage apparatus 20 is a magnetic tape library apparatus (near line storage apparatus), it may take time to read the data file. If the Graphical User Interface (GUI) displayed on the display device 8 of the user terminal 6 freezes during reading, the user convenience is reduced. Therefore, the agent application 40 displays a message for confirming the execution with an indication of that the data file has been moved to the tertiary storage apparatus 20 and that it takes time to move the data file. The agent application 40 executes the transmission process 42, after confirmation of the execution is accepted by the user operation on the confirmation message. The agent application 40 displays a message screen indicating that the process has been accepted, and then terminates or enters into a standby state. This prevents the user from being unable to perform another work until a desired data file is read out from the tertiary storage apparatus 20, thereby preventing the convenience of data usage by using the near line storage apparatus from being reduced. After confirming the message screen indicating that the process has been accepted, the user can operate the GUI of the user terminal 6 as if nothing had happened. Then, the data file recovered from the tertiary storage apparatus 20 is available in the same folder without user's awareness.

### Operation Example/Data Arrangement Method

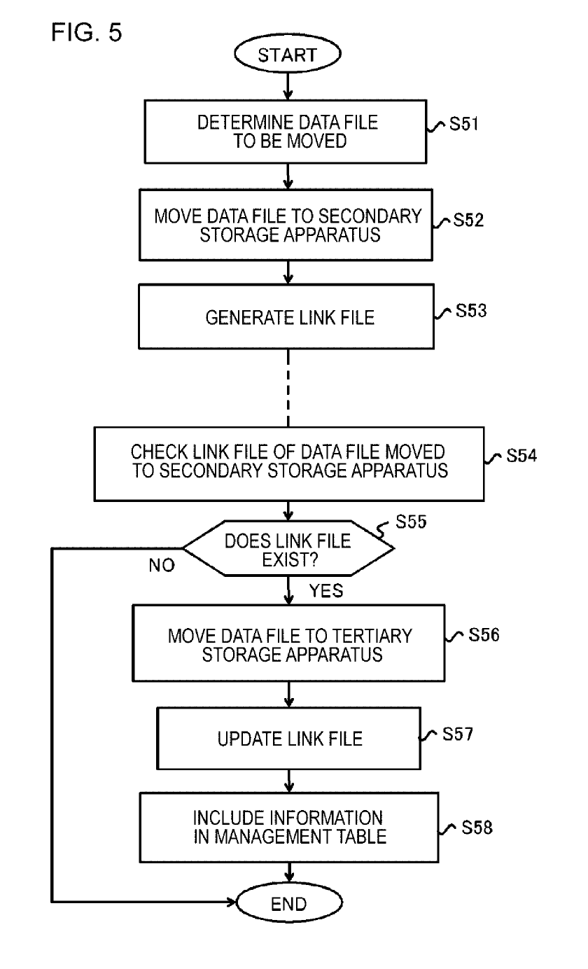

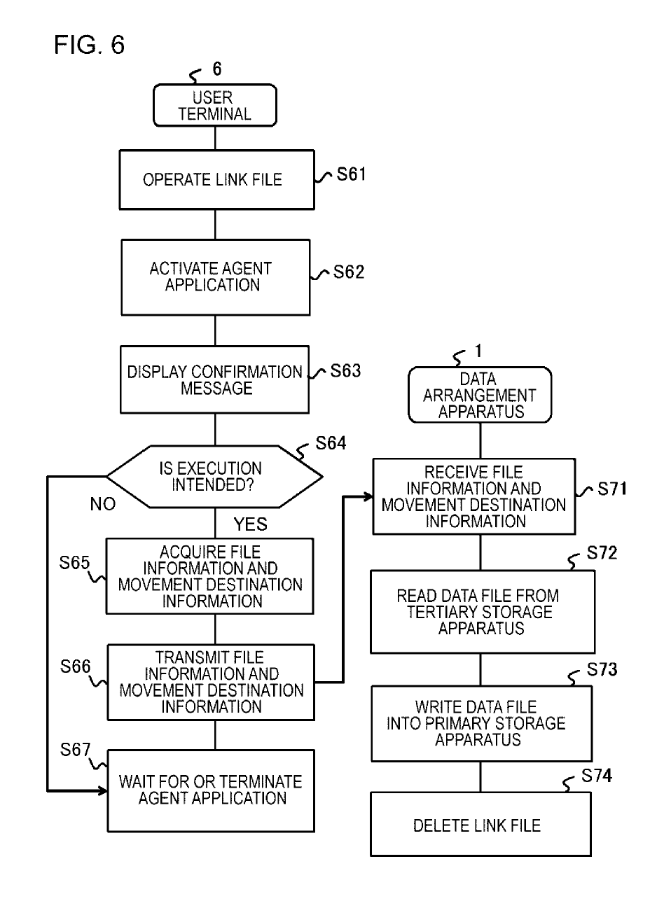

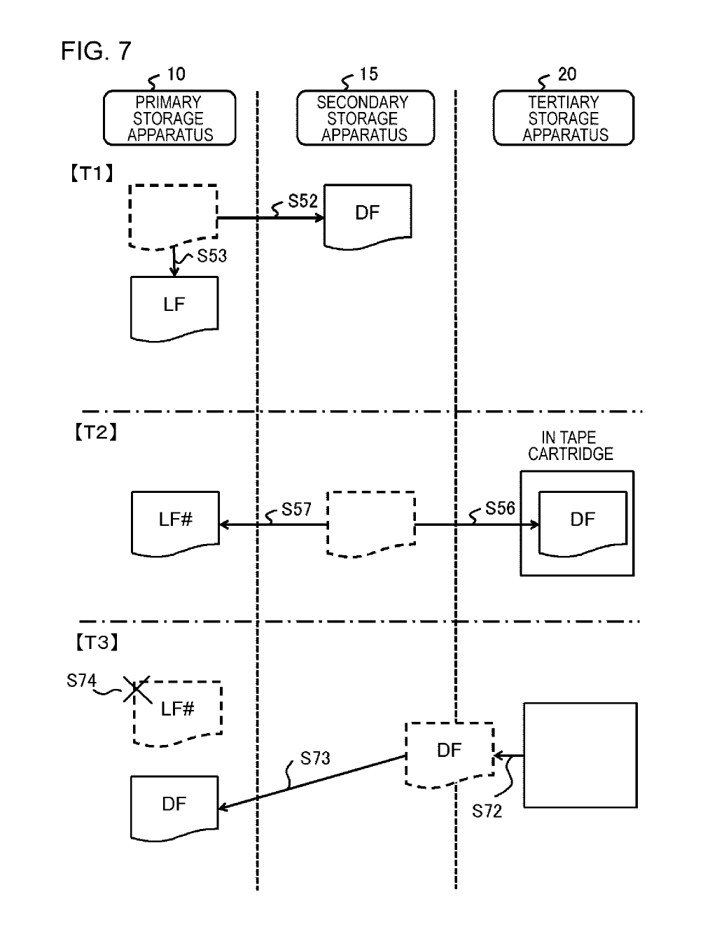

Hereinafter, the data arrangement method in the first exemplary embodiment will be described with reference to FIG. 5, FIG. 6, and FIG. 7. FIG. 5 and FIG. 6 are flowcharts showing operation examples of the data arrangement apparatus 1 and the user terminal 6 in the first exemplary embodiment. FIG. 7 is a diagram conceptually showing the transition of the arrangement of a data file. Each step shown in each drawing is executed by, for example, each processing module of the data arrangement apparatus 1 or the user terminal 6. Since each step is the same as each processing module described above which the data arrangement apparatus 1 has or the processing content of the user terminal 6, the details of each step are appropriately omitted.

FIG. 5 is a flowchart showing an operation example of the data arrangement apparatus 1 related to storage of a data file. The data file and the link file become the states T1 and T2 shown in FIG. 7 due to the operation of the data arrangement apparatus 1 shown in FIG. 5.

The data arrangement apparatus 1 detects a data file to be moved among a plurality of data files stored in the primary storage apparatus 10 (S51). The data arrangement apparatus 1 selects a data file to be moved to the secondary storage apparatus 15, out of a plurality of data files stored in the primary storage apparatus 10, depending on whether or not a no-access period and a file size satisfy a predetermined condition.

In a case where there is a data file to be moved, the data arrangement apparatus 1 moves the data file to the secondary storage apparatus 15 (S52). Further, the data arrangement apparatus 1 generates a link file in a folder on the primary storage apparatus 10 where the data file was stored (S53). The data arrangement apparatus 1 includes, in the link file, the storage location information of the data file in the secondary storage apparatus 15. The link file is generated, for example, as a shortcut file.

By executing (S51), (S52), and (S53), the data file DF and the link file LF are processed so as to be in the state T1. That is, the data file DF stored in the primary storage apparatus 10 is moved to the secondary storage apparatus 15, and the link file of the data file is generated in the primary storage apparatus 10.

After (S53), the data arrangement apparatus 1 checks the link file of the data file that has been moved in (S52) (S54). The time difference between the execution of (S53) and the execution of (S54) is arbitrary. During the time difference, the user may operate the user terminal 6 to delete the link file. The action of the user is regarded as indicating the intention to delete the data file corresponding to the link file. Therefore, in a case where the corresponding link file does not exists in the primary storage apparatus 10 (S54; NO), the data arrangement apparatus 1 cancels the movement of the data file. Further, the data arrangement apparatus 1 may delete such an orphan file from the secondary storage apparatus 15.

In a case where the corresponding link file exists (S55; YES), the data arrangement apparatus 1 moves the data file from the secondary storage apparatus 15 to the tertiary storage apparatus 20 (S56). At this time, it is desirable that the data arrangement apparatus 1 writes the copy of the data file into the tertiary storage apparatus 20 and deletes the original data file on the secondary storage apparatus 15 after the writing is finished.

Further, the data arrangement apparatus 1 updates the corresponding link file (S57). Specifically, the data arrangement apparatus 1 associates the link file with the trigger information for activating the agent application on the user terminal 6, and includes the movement destination information indicating the storage location of the tertiary storage apparatus 20 in the link file. Here, the identification information of the tape cartridge 22 that is the storage location of the data file in the tertiary storage apparatus 20 is set as the movement destination information.

In addition, the data arrangement apparatus 1 writes into the management table 34 the file information of the moved data file and the identification information of the tape cartridge 22 in which the data file is stored in association with each other (S58).

By executing (S54) to (S58), the data file DF and the link file LF# are processed so as to be in a state T2 (see FIG. 7). Since the link file is updated from the state T1 in the state T2, the link file in the state T2 is indicated by LF#. In the state T2, the data file DF stored in the secondary storage apparatus 15 is moved to the tape cartridge 22 of the tertiary storage apparatus 20, and the link file LF# on the primary storage apparatus 10 is updated.

FIG. 6 is a flowchart showing an operation example of the data arrangement apparatus 1 and the user terminal 6 at the time of access to the data file. Due to the operations of the data arrangement apparatus 1 and the user terminal 6 shown in FIG. 6, the data file is moved as shown in the state T3 of FIG. 7.

The user terminal 6 detects a user operation on the link file (S61). The user operation is, for example, a double click operation or a tap operation on an icon indicating the link file. In a case where the trigger information is not associated with the link file, that is, in a case where the corresponding data file is stored in the secondary storage apparatus 15, the user terminal 6 can open a corresponding data file, like the shortcut and the symbolic link. That is, the user terminal 6 can open the data file stored in the secondary storage apparatus 15, based on the storage location information included in the link file. The link file in this case is indicated by LF in FIG. 7.

In a case where the trigger information is associated with the link file, that is, in a case where the corresponding data file is stored in the tertiary storage apparatus 20, the user terminal 6 activates the agent application based on the trigger information (S62). The link file in this case is indicated by LF# in FIG. 7. The subsequent operation of user terminal 6 is realized by processing the agent application.

The user terminal 6 displays a confirmation message on the display device 8 (S63). The confirmation message indicates that the corresponding data file is stored in the tertiary storage apparatus 20 and it takes time to access the data file. If the user's intention is checked by a user operation on the confirmation message (S64; YES), the user terminal 6 acquires file information and movement destination information from the link file operated in (S61) (S65). Here, the identification information of the tape cartridge 22 that is the storage location of the data file in the tertiary storage apparatus 20 is acquired as the movement destination information.

The user terminal 6 transmits the acquired file information and the acquired movement destination information to the data arrangement apparatus 1 (S66). Thereafter, the user terminal 6 displays a message screen indicating that the process has been accepted, and causes the agent application to become a standby state or to terminate (S67). Thus, the GUI displayed on the display device 8 of the user terminal 6 becomes ready to accept other operations. Therefore, even in a case where the user accesses the data file stored in the tertiary storage apparatus 20, inconvenience that the GUI cannot be operated does not occur.

The data arrangement apparatus 1 receives file information and movement destination information from the user terminal 6 (S71). The data arrangement apparatus 1 reads the data file indicated by the received file information from the tape cartridge 22 indicated by the received movement destination information (S72). The data arrangement apparatus 1 stores the read data file in the same folder as the corresponding link file, on the primary storage apparatus 10 (S73). Furthermore, the data arrangement apparatus 1 deletes the link file (S74).

The data file DF and the link file LF# are processed so as to become state T3 according to the operation shown in FIG. 6 (see FIG. 7). In the state T3, the data file DF stored in the tape cartridge 22 of the tertiary storage apparatus 20 is read and stored in the primary storage apparatus 10, and the link file LF# on the primary storage apparatus 10 is deleted.

### Advantageous Effect in First Exemplary Embodiment

As described above, in the first exemplary embodiment, the primary storage apparatus 10 accessed by the user terminal 6, and the secondary storage apparatus 15 and the tertiary storage apparatus 20 for storing data are provided, and the arrangement of the data file on the primary storage apparatus 10 is controlled by the data arrangement apparatus 1. According to the first exemplary embodiment, it is possible to employ an expensive and high-speed disk array apparatus for the primary storage apparatus 10, and to employ an inexpensive and low-speed magnetic tape library apparatus having an increased capacity for the tertiary storage apparatus 20. Of course, it is also possible to employ an offline storage apparatus and a cloud storage other than the magnetic tape library apparatus as tertiary storage apparatus 20. According to the offline storage apparatus, power consumption can also be greatly reduced. Therefore, according to the first exemplary embodiment, the storage cost of data can be reduced.

In the first exemplary embodiment, a data file the no-access period and the file size of which satisfy a predetermined condition is selected from data files stored in the primary storage apparatus 10, and the data file is moved to the secondary storage apparatus 15. Since the data file to be moved is determined in this manner, it is possible to maintain the convenience of data usage. For example, since a data file the access frequency of which is low and the size of which is somewhat large is determined to be the movement target, it is possible to secure the free space of the primary storage apparatus 10 and to minimize the influence on the convenience of data usage due to the movement to the low speed secondary storage apparatus 15.

Furthermore, in the first exemplary embodiment, the data file moved to the secondary storage apparatus 15 is moved to the tertiary storage apparatus 20. That is, before the data file is moved to the near line storage apparatus, the data file is temporarily stored in the preceding storage apparatus (secondary storage apparatus 15) different from the near line storage apparatus. Not only because the access speed of the apparatus itself is low, but also because a switching time of the storage medium (such as the tape cartridge 22) may be required in some cases, writing the data file into the near line storage apparatus takes a longer time than other types of storage apparatus. In this way, the secondary storage apparatus 15 temporarily stores the data file before the tertiary storage apparatus 20 stores it, thereby being able to prevent the data file from being unable to be accessed until the data file is writing into the tertiary storage apparatus 20.

In the first exemplary embodiment, before moving the data file stored in the secondary storage apparatus 15 to the tertiary storage apparatus 20, the presence of the corresponding link file is checked, and in a case where the corresponding link file does not exists, the movement is canceled. Thus, it is possible to avoid an unnecessary data file (orphan file) from being stored in the tertiary storage apparatus 20.

In the first exemplary embodiment, if the data file is moved to the tertiary storage apparatus 20, trigger information for activating the agent application on the user terminal 6 is associated with the link file of the data file, and the identification information of the tape cartridge 22 is included as movement destination information. When the link file is operated by the user, the agent application is activated on the user terminal 6, and the file information and the movement destination information are provided from the agent application to the data arrangement apparatus 1. Then, a desired data file is read out from a certain tape cartridge 22, recovered to the primary storage apparatus 10, and the user can access the data file.

As described above, according to the first exemplary embodiment, it is possible to access the data file stored in the near line storage apparatus such as the magnetic tape library apparatus only by the operation on the link file. Accordingly, it is possible to use the data with the same operation as the operation for the data file stored in the disk device while using the near line storage apparatus having a low data storage cost, and thereby reducing the data storage cost without reducing the convenience of data usage.

### First Modification of First Exemplary Embodiment

In the above-mentioned first exemplary embodiment, the link file is placed only on the primary storage apparatus 10. However, the link file may be placed in each of the primary storage apparatus 10 and secondary storage apparatus 15 (first modification).

In the first modification, in a case where the data file is moved from the primary storage apparatus 10 to the secondary storage apparatus 15, the arrangement control unit 32 generates the first link file on the primary storage apparatus 10. This first link file is similar to that of the first exemplary embodiment. In a case where the data file is moved from the secondary storage apparatus 15 to the tertiary storage apparatus 20, the arrangement control unit 32 generates the second link file on the secondary storage apparatus 15, the second link file being associated with the trigger information and including the file information and the identification information of the tape cartridge 22 storing the data file. In addition, the arrangement control unit 32 changes the storage location information in the corresponding first link file on the primary storage apparatus 10 to the path of the second link file. Thereby, the first link file on the primary storage apparatus 10 indicates the location of the second link file on the secondary storage apparatus 15, and the second link file indicates the location of the data file stored in the tertiary storage apparatus 20.

Upon detecting the user operation of the first link file, the user terminal 6 accesses the second link file on the secondary storage apparatus 15, based on the storage location information in the first link file. Thus, the agent application is activated on the user terminal 6 by the trigger information associated with the second link file. The information acquisition process 41 of the agent application acquires file information and movement destination information from the second link file. When recovering the data file to the primary storage apparatus 10, the recovery unit 37 deletes the first link file and the second link file. The other processes are the same as in the first exemplary embodiment. Even in the first modification, it is possible to obtain the same effect as in the above-mentioned first exemplary embodiment.

### Second Modification of First Exemplary Embodiment

Further, the plurality of storage apparatuses may be formed not only in three layers but also in four or more layers (second modification). In this case, it is desirable that the storage apparatus of the lowest layer is a near line storage apparatus, and the storage apparatus of the upper layer is a storage apparatus of a type different from the near line storage apparatus, such as a disk apparatus.

In the second modification, in a case where the type of the storage apparatus of the movement destination of the data file is a near line storage apparatus, the trigger information is associated with the corresponding link file. In a case where the secondary and tertiary storage apparatuses are disk apparatuses and the data file is moved from the secondary storage apparatus to the tertiary storage apparatus, the arrangement control unit 32 changes the storage location information in the link file on the primary storage apparatus 10 from the storage location on the secondary storage apparatus to the storage location on the tertiary storage apparatus. Even in the second modification, it is possible to obtain the same effect as in the above-mentioned first exemplary embodiment.

### Third Modification of First Exemplary Embodiment

Further, the plurality of storage apparatuses may be formed in two layers. That is, a near line storage apparatus (such as a magnetic tape library apparatus) may be employed for the secondary storage apparatus 15. In this case, when the data file is moved from the primary storage apparatus 10 to the secondary storage apparatus 15, the arrangement control unit 32 generates a link file with which trigger information is associated, and which includes the identification information of the tape cartridge 22 storing the file information and the data file, on the primary storage apparatus 10. In the operation example of FIGS. 5, (S54) to (S57) are unnecessary. In the operation example of FIG. 6, in (S72), the data arrangement apparatus 1 reads the data file from the secondary storage apparatus 15.

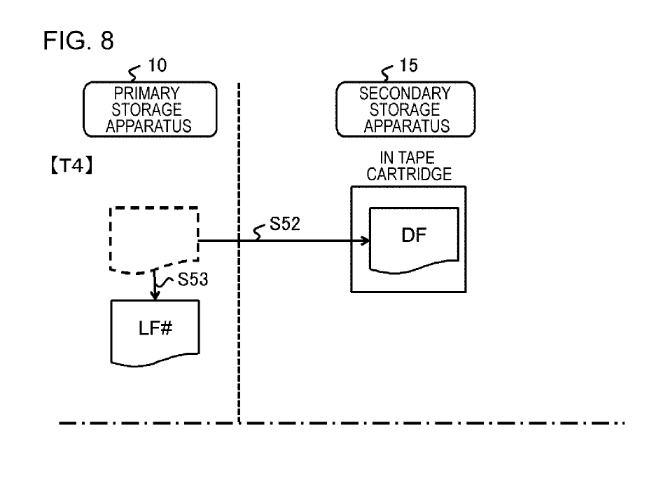

FIG. 8 is a diagram conceptually showing transition of arrangement of a data file in the third modification. By executing (S51) to (S53) illustrated in FIG. 6, the data file DF and the link file LF# are processed so as to be in a state T4. In the state T4, the data file DF stored in the primary storage apparatus 10 is moved to the tape cartridge 22 of the secondary storage apparatus 15, and the link file LF# on the primary storage apparatus 10 is generated.

When moving the data file from the primary storage apparatus 10 to the secondary storage apparatus 15, it is desirable that the file moving unit 31 writes the copy of the data file into the secondary storage apparatus 15, and deletes the original data file on the primary storage apparatus 10 after the writing is finished. This makes it possible to prevent the data file from being unable to be accessed while writing the data file into the secondary storage apparatus 15.

### Second Exemplary Embodiment

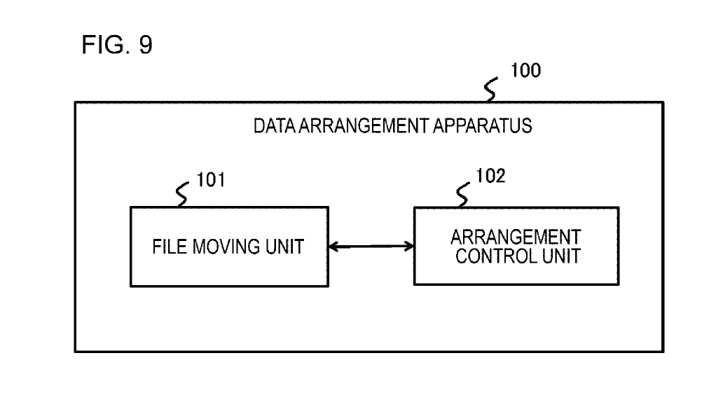

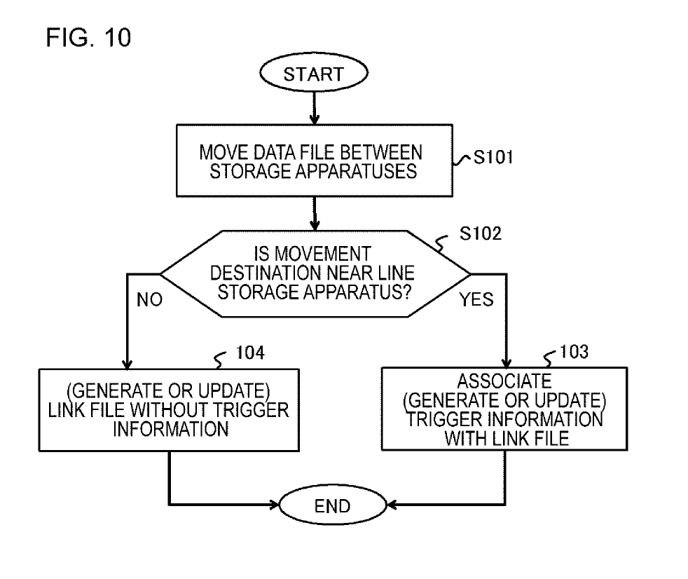

The data arrangement apparatus and the data arrangement method of the second exemplary embodiment will be described with reference to FIG. 9 and FIG. 10. Further, the second exemplary embodiment may be a program causing at least one computer to execute the data arrangement method, or a storage medium that can be read by the at least one computer having the program stored therein.

FIG. 9 is a diagram conceptually showing a processing configuration example of the data arrangement apparatus 100 in the second exemplary embodiment. As shown in FIG. 9, the data arrangement apparatus 100 includes a file moving unit 101 and an arrangement control unit 102. The data arrangement apparatus 100 shown in FIG. 9 includes, for example, the same hardware configuration as the above-described data arrangement apparatus 1 shown in FIG. 1, and the above-described processing modules are realized by processing the program in the same manner as the data arrangement apparatus 1.

The file moving unit 101 moves a data file stored in the storage apparatus to a different storage apparatus. The storage apparatuses that are candidates for a movement destination of the data file include the above-mentioned near line storage apparatus including an offline storage apparatus and a cloud storage.

In a case where the data file is moved between storage apparatuses by the file moving unit 101, the arrangement control unit 102 determines whether or not to associate trigger information for activating the agent application on the user terminal with a link file of the data file to be moved, based on the type of the storage apparatus of the movement destination. Specifically, the arrangement control unit 102 associates the trigger information with the link file in a case where the storage apparatus of the movement destination is the above-mentioned near line storage apparatus, whereas the arrangement control unit 102 does not associate the trigger information with the link file in a case where the storage apparatus of the movement destination is a storage apparatus other than the near line storage apparatus.

The agent application activated on the user terminal is the same as in the first exemplary embodiment. In a case where the data arrangement apparatus 100 itself communicates with the agent application, similarly to the first exemplary embodiment, the data arrangement apparatus 100 may further include the receiving unit 35, the reading unit 36, and the recovery unit 37. Further, another apparatus may include the receiving unit 35, the reading unit 36, and the recovery unit 37. In this case, the file information and movement destination information transmitted by the agent application is received by another apparatus.

FIG. 10 is a flowchart showing an operation example of the data arrangement apparatus 100 of the second exemplary embodiment. As shown in FIG. 10, the data arrangement method in the second exemplary embodiment is executed by at least one computer, such as the data arrangement apparatus 100. For example, the illustrated respective steps are executed by each processing module of the data arrangement apparatus 100.

The data arrangement method of the second exemplary embodiment includes moving a data file stored in the storage apparatus to a different storage apparatus (S101). (S101) corresponds to (S52) and (S56) in FIG. 5.

The data arrangement method further includes selecting whether or not to associate trigger information for activating the agent application on the user terminal with a link file of the data file to be moved, based on the type of the storage apparatus of a movement destination. Specifically, the data arrangement apparatus 100 determines whether or not the type of the storage apparatus that is the movement destination of the data file in (S101) is the near line storage apparatus (S102). In a case where the storage apparatus which is the movement destination is the near line storage apparatus (S102; YES), the data arrangement apparatus 100 associates the trigger information with the corresponding link file (S103). (S103) indicates generating the link file with which the trigger information is associated, and newly associating the trigger information with the link file. In a case where the storage apparatus that is the movement destination is a storage apparatus other than the near line storage apparatus (S102; NO), the data arrangement apparatus 100 generates or updates the link file without associating trigger information with the link file (S104).

According to the second exemplary embodiment, it is possible to obtain the same advantageous effect as in the first exemplary embodiment and the respective modifications described above.

Note that, in the plurality of flowcharts used in the above description, a plurality of steps (processes) are described in order, but the execution order of the steps is not limited to the order in the description. In each exemplary embodiment, it is possible to change the order of shown steps within a range that does not hinder the contents. In addition, the respective exemplary embodiments and the respective modifications described above can be combined within a range in which the contents do not contradict each other.

A part or all of the respective exemplary embodiments and the respective modifications can also be determined as follows. However, the respective exemplary embodiments and the respective modifications are not limited to the following description.

1. A data arrangement apparatus including

a file moving unit that moving a data file stored in a storage apparatus to a different storage apparatus, and

an arrangement control unit that determining whether or not to associate trigger information for activating an agent application on a user terminal with a link file of the data file to be moved when the data file is moved between storage apparatuses by the file moving unit, based on a type of a storage apparatus of a movement destination.

2. The data arrangement apparatus according to 1.,

wherein the file moving unit determines the data file to be moved to a different storage apparatus out of a plurality of data files stored in the storage apparatus, based on whether or not a no-access period and a file size satisfy a predetermined condition.

3. The data arrangement apparatus according to 1. or 2., wherein when the type of the storage apparatus of the movement destination is a near line storage apparatus, the arrangement control unit associates the trigger information with the link file, and includes, in the link file, file information of the data file and movement destination information indicating a storage location of the storage apparatus of the movement destination, the near line storage apparatus including a cloud storage and an offline storage apparatus in which a plurality of removable storage media can be switched and used.

4. The data arrangement apparatus according to 3., wherein the arrangement control unit includes identification information of the storage medium in the link file as the movement destination information when the type of the storage apparatus of the movement destination is the offline storage apparatus.

5. The data arrangement apparatus according to 4., further includes a storage processing unit writing, into a storage unit, the identification information of the storage medium and the file information of each data file written in the storage medium in association with each other.

6. The data arrangement apparatus according to any one of 3. to 5.,

wherein the file moving unit moves the data file to a preceding storage apparatus different from the near line storage apparatus before moving the data file to the near line storage apparatus, and

wherein the arrangement control unit includes information indicating a storage location on the preceding storage apparatus in the link file of the data file that is stored in the primary storage apparatus accessed by a user, when the data file is moved to the preceding storage apparatus, and

wherein the arrangement control unit associates the trigger information with the link file, and includes in the link file, the information indicating a storage location on the near line storage apparatus, when the data file is moved from the preceding storage apparatus to the near line storage apparatus.

7. The data arrangement apparatus according to any one of 3. to 6. further including

a receiving unit receiving the movement destination information and the file information transmitted from the user terminal by executing the agent application,

a reading unit reading the data file indicated by the received file information from the storage location of the near line storage apparatus indicated by the received movement destination information, and

a recovery unit placing the data file read by the reading unit in a folder where the link file of the data file exists, and deleting the link file.

8. The data arrangement apparatus according to any one of 3. to 7., wherein the arrangement control unit updates the link file on the primary storage apparatus accessed by a user so as to be displayed as an icon image corresponding to the near line storage apparatus when the data file is moved to the near line storage apparatus, the link file relating to the data file.

9. The data arrangement apparatus according to any one of 1. to 8., wherein the file moving unit checks the presence of the link file of the data file before moving the data file stored in the storage apparatus different from the primary storage apparatus accessed by the user to a different storage apparatus, and cancels the movement of the data file when the link file does not exist.

10. A data arrangement method executed by at least one computer accessible to a plurality of storage apparatuses, including:

moving a data file stored in a storage apparatus to a different storage apparatus; and

determining whether or not to associate trigger information for activating an agent application on a user terminal with a link file of the data file to be moved, based on the type of the storage apparatus of a movement destination.

11. The data arrangement method according to 10., further including determining the data file to be moved to a different storage apparatus out of a plurality of data files stored in the storage apparatus, based on whether or not a no-access period and a file size satisfy a predetermined condition.

12. The data arrangement method according to 10. or 11, further including, when the type of the storage apparatus of the movement destination is a near line storage apparatus, associating the trigger information with the link file, and includes, in the link file, the file information of the data file and movement destination information indicating a storage location of the storage apparatus of the movement destination, the near line storage apparatus including a cloud storage and an offline storage apparatus in which a plurality of removable storage media can be switched and used.

13. The data arrangement method according to 12., further comprising including identification information of the storage medium in the link file as the movement destination information when the movement destination information is included in the link file and when the type of the storage apparatus of the movement destination is the offline storage apparatus.

14. The data arrangement method according to 13., further including writing, into a storage unit, the identification information of the storage medium and the file information of each data file written in the storage medium in association with each other.

15. The data arrangement method according to any one of 12. to 14., further including:

moving the data file to a preceding storage apparatus different from the near line storage apparatus before moving the data file to the near line storage apparatus;

including information indicating a storage location on the preceding storage apparatus in the link file of the data file that is stored in the primary storage apparatus accessed by a user, when the data file is moved to the preceding storage apparatus; and

associating the trigger information with the link file, and including information indicating a storage location on the near line storage apparatus in the link file, when the data file is moved from the preceding storage apparatus to the near line storage apparatus.

16. The data arrangement method according to any one of 12. to 15., further including:

receiving the movement destination information and the file information transmitted from the user terminal by executing the agent application;

reading the data file indicated by the received file information from the storage location of the near line storage apparatus indicated by the received movement destination information; and

placing the read data file in the folder where the link file of the data file exists and deleting the link file.

17. The data arrangement method according to any one of 12. to 16., further including updating the link file on the primary storage apparatus accessed by a user so as to be displayed as an icon image corresponding to the near line storage apparatus when the data file is moved to the near line storage apparatus, the link file relating to the data file.

18. The data arrangement method according to any one of 10. to 17., further including:

checking the presence of the link file of the data file before moving the data file stored in the storage apparatus different from the primary storage apparatus accessed by the user to a different storage apparatus; and

cancelling the movement of the data file when the link file does not exist.

19. A program causing at least one computer to execute the data arrangement method according to any one of 10. to 18.

20. A program for an agent application executed by a user terminal accessible to a primary storage apparatus,

wherein the agent application is activated by a user operation on a link file on the primary storage apparatus, the link file being generated for a data file stored in a near line storage apparatus including a cloud storage and an offline storage apparatus in which a plurality of removable storage media can be switched and used, and

wherein the agent application includes:

an information acquisition process of acquiring file information of the data file and movement destination information from the link file; and

a transmission process of transmitting the file information and the movement destination information to a data arrangement apparatus accessible to the primary storage apparatus and the near line storage apparatus, in order for the data arrangement apparatus to move the data file from the near line storage apparatus to the primary storage apparatus.

21. The program according to 20., wherein the agent application displays the confirmation message on the display unit of the user terminal, executes the transmission process after checking the user's intention by the user operation on the confirmation message, and enters into a standby state or terminates the process after executing the transmission process.

22. A storage medium storing the program according to 19. to 21. so as to be readable by a computer.

This application claims priority based on Japanese Patent Application No. 2015-030619 filed on Feb. 19, 2015, and the disclosure of which is incorporated herein in its entirety.

What is claimed is:

1. A data arrangement apparatus comprising:
a file moving unit moving a data file stored in a storage apparatus to a different storage apparatus; and
an arrangement control unit determining whether or not to associate trigger information for activating an agent application on a user terminal with a link file of the data file to be moved when the data file is moved between storage apparatuses by the file moving unit, based on a type of a storage apparatus of a movement destination.

2. The data arrangement apparatus according to claim 1, wherein the file moving unit determines the data file to be moved to the different storage apparatus out of a plurality of data files stored in the storage apparatus, based on whether or not a no-access period and a file size satisfy a predetermined condition.

3. The data arrangement apparatus according to claim 1, wherein when the type of the storage apparatus of the movement destination is a near line storage apparatus, the arrangement control unit associates the trigger information with the link file, and includes, in the link file, file information of the data file and movement destination information indicating a storage location of the storage apparatus of the movement destination, the near line storage apparatus including a cloud storage and an offline storage apparatus in which a plurality of removable storage media can be switched and used.

4. The data arrangement apparatus according to claim 3, wherein the arrangement control unit includes identification information of a storage medium in the link file as the movement destination information when the type of the storage apparatus of the movement destination is the offline storage apparatus.

5. The data arrangement apparatus according to claim 4, further comprising a storage processing unit writing, into a storage unit, the identification information of the storage medium and file information of each data file written in the storage medium in association with each other.

6. The data arrangement apparatus according to claim 3,
wherein the file moving unit moves the data file to a preceding storage apparatus different from the near line storage apparatus before moving the data file to the near line storage apparatus,
wherein the arrangement control unit includes information indicating a storage location on the preceding storage apparatus in the link file of the data file that is stored in the primary storage apparatus accessed by a user, when the data file is moved to the preceding storage apparatus, and
wherein the arrangement control unit associates the trigger information with the link file, and includes the information indicating a storage location on the near line storage apparatus in the link file, when the data file is moved from the preceding storage apparatus to the near line storage apparatus.

7. The data arrangement apparatus according to claim 3, further comprising:
a receiving unit receiving the movement destination information and the file information transmitted from the user terminal by executing the agent application;
a reading unit reading the data file indicated by the received file information from the storage location of the near line storage apparatus indicated by the received movement destination information; and
a recovery unit placing the data file read by the reading unit in a folder where the link file of the data file exists, and deleting the link file.

8. The data arrangement apparatus according to claim 3, wherein the arrangement control unit updates the link file on the primary storage apparatus accessed by a user so as to be displayed as an icon image corresponding to the near line storage apparatus when the data file is moved to the near line storage apparatus, the link file relating to the data file.

9. The data arrangement apparatus according to claim 1, wherein the file moving unit checks the presence of the link file of the data file before moving the data file stored in the storage apparatus different from the primary storage apparatus accessed by the user to the different storage apparatus, and cancels the movement of the data file when the link file does not exist.

10. A data arrangement method executed by at least one computer accessible to a plurality of storage apparatuses, the method comprising:
moving a data file stored in a storage apparatus to a different storage apparatus; and
determining whether or not to associate trigger information for activating an agent application on a user terminal with a link file of a data file to be moved, based on a type of a storage apparatus of a movement destination.

11. A non-transitory computer-readable storage medium storing a program causing at least one computer to execute the data arrangement method according to claim 10.

12. A non-transitory computer-readable storage medium storing a program for an agent application executed by a user terminal accessible to a primary storage apparatus,
wherein the agent application is activated by a user operation on a link file on the primary storage apparatus, the link file being generated for a data file stored in a near line storage apparatus including a cloud storage and an offline storage apparatus in which a plurality of removable storage media can be switched and used, and
wherein the agent application comprising:
an information acquisition process of acquiring file information of the data file and movement destination information from the link file; and
a transmission process of transmitting the file information and the movement destination information to a data arrangement apparatus accessible to the primary storage apparatus and the near line storage apparatus, in order for the data arrangement apparatus to move the data file from the near line storage apparatus to the primary storage apparatus.
